(19) United States
(12) Patent Application Publication
(10) Pub. No.: US 2006/0293057 A1
(43) Pub. Date: Dec. 28, 2006

(54) System and method for secure web-based mobile phone parental controls

(76) Inventors: Thomas Mathew Mazerski, Mount Airy, MD (US); Thomas Edward Mazerski, Mount Airy, MD (US); Randy Allen Moore, Silver Spring, MD (US); Joseph Meadows Taylor, Centreville, MD (US); Martin B. Gotlieb, Silver Spring, MD (US); Marilyn Leavey Meyerson, Reisterstown, MD (US)

Correspondence Address: OBER / KALER;c/o Royal W. Craig, 120 East Baltimore Street, Baltimore, MD, 21202, US

(21) Appl. No.: 11/225,269

(22) Filed: Sep. 13, 2005

Related U.S. Application Data
(60) Provisional application No. 60/693,288, filed on Jun. 24, 2005.

(51) Int. Cl. H04Q 7/20

(52) U.S. Cl. 455/445; 455/428

(57) ABSTRACT

A wireless system and method for implementing call controls (such as parental controls) for wireless telephones via a call-intercept platform (including a soft switch and/or an SS7 interconnection node, and SQL database), and a conventional mobile phone that makes and receives all outgoing calls through the call intercept platform. The call intercept platform includes secure web server to provide a secure website point of entry for allowing parents to specify a ruleset of parental controls that is stored in the SQL database. Every outgoing call from the mobile phone is routed into the call-intercept platform, which logs the call, crosschecks the mobile phone and outgoing call number against the stored ruleset for that phone/user, and selectively screens te calls. Incoming calls are automatically forwarded from the wireless carrier to the call intercept platform and are logged, cross-checked and selectively screened. The secure web portal allows parents and guardians or other individuals who desire to self-limit call usage to thoroughly manage their dependent's or their own phone, inclusive of viewing calls, activating and deactivating controls, customizing controls, as well as purchasing prepaid minutes and managing their accounts.

### CROSS-REFERENCE TO RELATED APPLICATIONS

The present application derives priority from provisional patent application No. 60/693,288, filed Jun. 23, 2005.

### BACKGROUND OF THE INVENTION

1. Field of the Invention

The present invention relates to wireless telephones and, more particularly, to a system for implementing parental controls and call monitoring for wireless telephones via a call-intercept platform.

2. Description of the Background

Twenty years ago wireless phones cost thousands of dollars (about $3000 each), airtime was more than $1.30 per minute, and there were less than 100,000 U.S. wireless phone subscribers. Today, an expensive high-end mobile phone cost about $200. Moreover, airtime ranges between $0.05-0.30 per minute, and sharing a family pool of airtime minutes adds only $10 to the monthly service charge. Indeed, the primary purpose of the cell phone is growing away from business use toward family use, as they make it much easier for family members to stay in touch with each other.

Conventional mobile phones give the ability to customize the phone by changing the handset color, ring tone, song, menus, preferences, user interface, volume, speed dials, and voice mail announcements. Modem phones also support Internet Access, the ability to have personalized “Net” preferences, contact lists, pictures taken and even applications that are downloaded from and transmitted through the Internet. This high degree of customization allows individual expression: a statement of identity. No market segment is more interested in expressing their identity than teenagers. Not surprisingly, cell phones have become the latest must-have accessory for teenagers. Cell phones have become so popular that more than half of all teenagers now own one. In some high schools, 80 percent of the students have phones. School administrators have had to enact strict rules to deal with them. Most schools prohibit using the devices during school hours. If students disobey, the phones usually are seized and kept in the principal's office until the end of the school day.

Parents generally favor their children having a mobile phone because it keeps them connected, especially if they get into trouble. However, this benefit comes at a cost. Teens are also much more likely to use extra features, including different ring tones, text messaging, games, Internet connectivity, and cameras. They are also much more frequent callers, and often spend hours chatting with their friends. This means that monthly bills sometimes can get excessive and well out of hand. Though wireless companies are marketing to teens aggressively, they say it's the responsibility of parents to control their children. The only current recommendation for parents is to get a pre-paid plan with a limit on it. There are a few companies that plan to introduce phones that are hardwired to limit themselves to 30 minutes of talk time. The general concept of parental controls for wireless/cellular phones is not new. Last year, Tecore launched a wireless family plan, which provides parents the ability to control the shared usage of prepaid minutes. Also, U.S. Patent Application Ser. No. 20050096009 to Ackley discloses a method for cell phone parental control. Parents are provided with the ability to select a list of approved anytime incoming communications, or approved incoming and outgoing communications based on time and day. However, this is accomplished by screening based on time of day (e.g. parents screen kids calls during school hours), and downloading the time parameters into the cell phones, which is a cumbersome process.

It would be much more advantageous to provide a more efficient system for implementing mobile phone parental controls via a third party web-enabled server for managing outgoing calls by intercepting and screening them, and for allowing parents to specify their rules through an easy graphical user interface.

### SUMMARY OF THE INVENTION

Accordingly, it is an object of the present invention to provide a system and method for allowing customizable parental controls for wireless telephones via a unique call-intercept platform architecture, inclusive of a web server, a sequel (SQL) server, a soft switch, and/or an SS7 interconnection node

It is another object to provide parents with a simple, secure web portal for thoroughly managing their child's phone, inclusive of viewing calls, activating and deactivating parental controls, customizing parental controls, as well as purchasing prepaid minutes and managing their accounts, by eliminating unwanted monthly call usage overcharges.

According to the present invention, the above-described and other objects are accomplished by providing a wireless system and method for implementing parental controls for wireless telephones via a call-intercept platform, and a conventional mobile phone that is pre-programmed to make all outgoing calls through the call intercept platform. The call intercept platform includes a secure website point of entry for allowing parents to specify a ruleset of parental controls, which is stored in database of a sequel server (SQL) that is part of the call intercept platform.

Every outgoing call is routed into a soft switch (also part of the call intercept platform) and/or an SS7 interconnection node, which crosschecks the mobile phone's identity and the outgoing call number against the stored ruleset of permissible 10-digit numbers for that phone/user. Outgoing calls are screened accordingly and acceptable calls are handed off to an established wireless carrier. Outgoing calls are also logged, and parents can review call usage on a real-time basis at the secure website point of entry. Incoming calls are similarly screened and logged, though incoming calls must first be rerouted from the wireless carrier to the call intercept platform for processing.

The secure web portal allows parents to thoroughly manage their child's phone, inclusive of viewing calls, activating and deactivating parental controls, customizing parental controls, as well as purchasing prepaid minutes and managing their accounts, by eliminating unwanted monthly call usage overcharges.

Of course, the above-described system is not be limited in context to parents and their children, but affords superior call control in the context of any guardian-type relationship or self-imposed limited use basis.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a general flow chart of the present method.

FIG. 2 is a listing of the various usage plans offered.

FIG. 3 is a block diagram of the architecture of the system of the present invention, inclusive of call intercept platform as well as the user of the wireless device and parental interface.

### DETAILED DESCRIPTION OF THE PREFERRED EMBODIMENTS

The present invention is a wireless system and method for implementing parental controls for wireless telephones via a call-intercept web server, sequel server (SQL), soft switch, and/or an SS7 interconnection node. The wireless system and method provides parents with a simple, secure web portal for thoroughly managing their child's phone, inclusive of viewing calls, activating and deactivating parental controls, customizing parental controls, as well as purchasing prepaid minutes and managing their accounts, by eliminating unwanted monthly call usage overcharges.

The present system accomplishes the foregoing with a conventional mobile phone that is preprogrammed to make all outgoing calls through a call intercept platform, the call intercept platform itself for controlling the outgoing calls, and a secure website point of entry for allowing parents to specify parental controls to the call intercept platform. Incoming calls are similarly screened and logged by rerouted them from the wireless carrier to the call intercept platform for processing. Of course, the present system should not be limited in context to parents and their children, but affords call control in the context of any guardian-type relationship or self-imposed limited call usage basis.

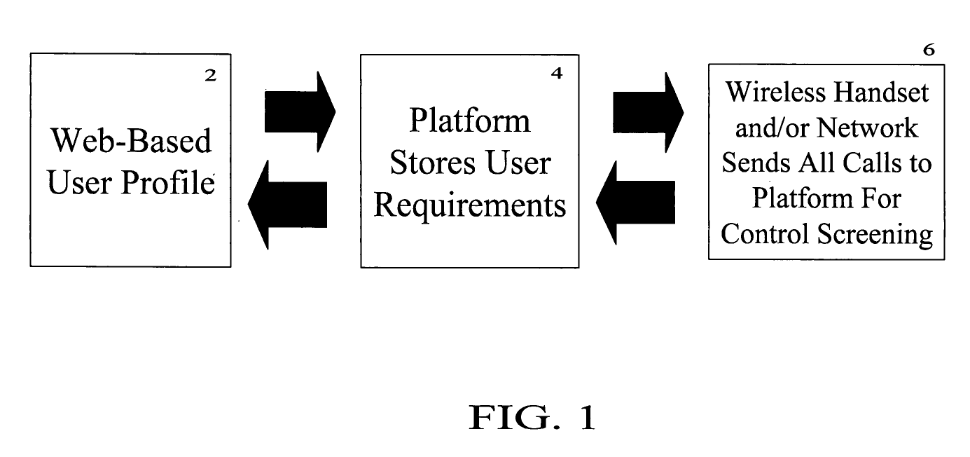

FIG. 1 is a general flow chart of the present method. Initially, parents are sold a wireless service and one or more mobile phones for their children. The service may be pre paid, post paid, or a combination of pre and post paid wireless service, in all cases including the ability for individually designed parental/self controls.

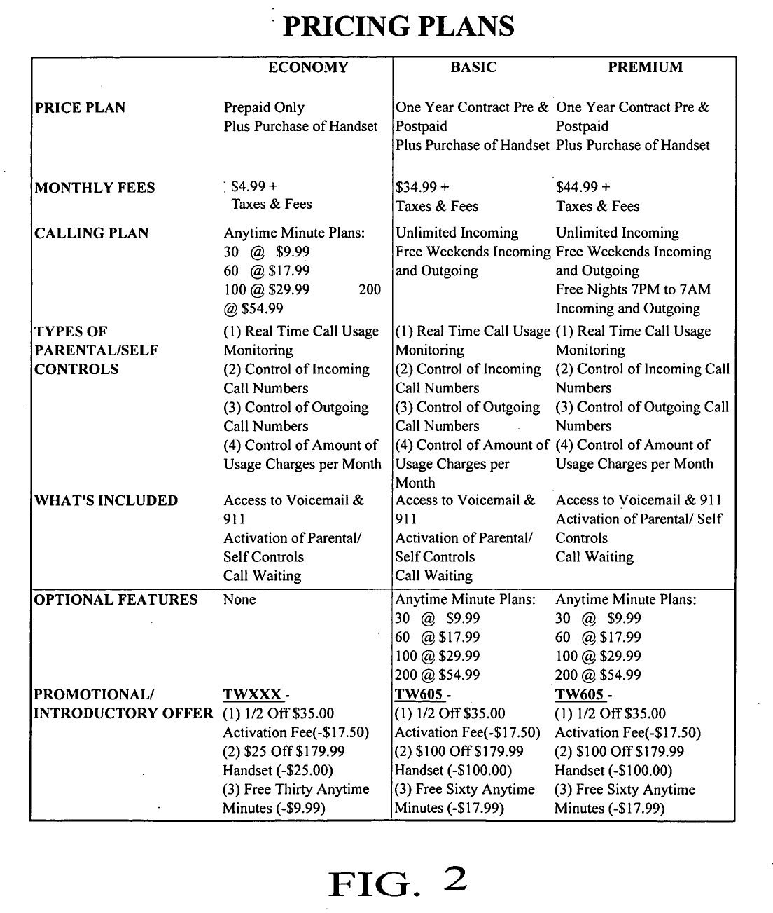

FIG. 2 is a listing of the various usage plans offered, which include an Economy (prepaid) plan, a Basic plan (post-paid) with allocated minutes, and a Premium Plan (post-paid) with additional allocated minutes.

The mobile phone(s) are conventional hardware devices with inbuilt keypads designed to operate by a combination of radio wave transmission and conventional telephone circuit switching. Suitable mobile phones are available from Alcatel, Audiovox, Kyocera, LG, Motorola, Nokia, Panasonic (Matsushita Electric), Philips, Samsung, Sagem, Sanyo, Siemens, SK Teletech, and Sony Ericsson. Other mobile phones becoming available in the future may be suitable as well. In accordance with the present invention, the mobile phone(s) employed herein are programmed to initiate any outgoing call by connecting to the call intercept platform of the present invention.

Given their new mobile phone(s) and service plan, parents must first create a user profile and define their parental controls ruleset for each child (each purchased mobile phone). At step 2 (FIG. 1), parents employ their own computer to access, or have the option to request a Customer Service Representative (CSR) to access, the secure website point of entry to complete a User Profile and Ruleset for the purchased mobile phone(s). At step 4, the parental-completed User Profile Ruleset is communicated to the call intercept platform and is stored there. At step 6, the child-user initiates an outbound call, which is sent to the call intercept platform (soft switch 80 and/or SS7 interconnection node 90 as will be described) via one of six options: (1) manually dialing the 10-digit telephone number of the soft switch; or, (2) depressing a preprogrammed Speed Dial Number of the soft switch; (3) manually dialing the destination 10-digit number; (4) depressing a preprogrammed Speed Dial Number of the destination 10-digit number; (5) the mobile phone 50 is programmed to initiate all outgoing calls by first dialing the dedicated number of the call intercept platform, and then transmitting the destination call number; or, (6) the mobile phone 50 signals to an SS7 interconnection node 90. When the soft switch 80 is dialed (options 1 & 2), the caller then will be prompted to enter their desired destination 10-digit telephone number. When the ten-digit destination number is dialed (options 3,4 & 5) the established wireless carrier automatically reroutes the outgoing call to the soft switch 80. When an SS7 interconnection node 90 is utilized (option 6), the wireless carrier automatically sends information, including the dialed number to the SS7 interconnection node, along with the identity of the mobile phone 50. Thus, every outgoing call is routed through the call intercept platform, and the mobile phone 50 is identified along with the destination call number. The outgoing call is crosschecked against the stored User Profile Ruleset for that phone 50, and calls are screened accordingly. Acceptable calls are handed off to an established wireless carrier. In this manner, parents can manage/restrict all incoming and/or outgoing calls to and/or from their child's particular mobile phone based on a variety of programmable rules (parent-specified numbers, time of day operation, etc.). Moreover, parents can review call usage on a real-time basis at the secure website point of entry. Similarly, all incoming calls through the wireless carrier are screened and logged by rerouted them from the wireless carrier to the call intercept platform.

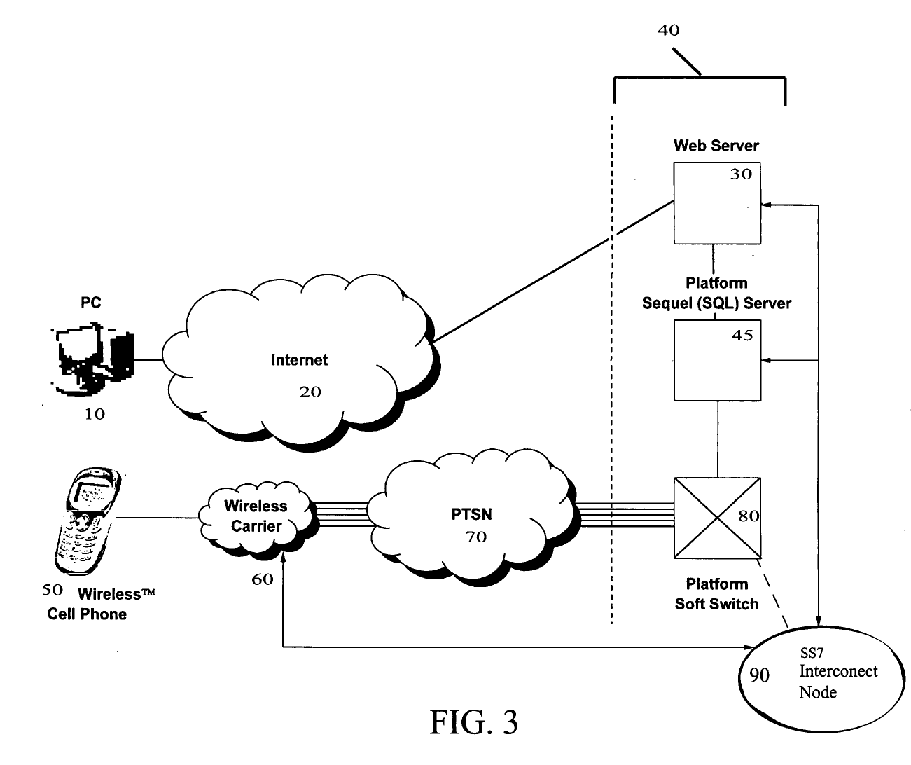

FIG. 3 is a block diagram of the architecture of the system of the present invention, inclusive of call intercept platform as well as the user of the wireless device and parental interface.

The present call intercept platform 40 includes one or more independent secure web-enabled server(s) 30, SQL Server(s) 45 and soft switches 80 (software switching solutions) in network communication with the web servers 30 to interface with and support packet communications there between.

The soft switch 80 is a conventional software switching solution that serves as a call interface or gateway between networks (here the PSTN 70 and back-end web-servers 45) by translating control signals from one protocol, such as IP based packet data with PSTN or relevant protocol for interfacing to the PSTN 70. There are a variety of suitable soft switches 80 that will suffice for present purposes, such as Alcatel's Spatial Atrium solution. The soft switch 80 software is preferably supported on one or more dedicated server computer(s), but may alternatively be supported on the web-enabled server(s) 30 or SQL Server(s) 45.

Depending on the desired call intercept configuration to be deployed (as described above), an SS7 interconnect node 90 may be employed in addition to or in lieu of soft switches 80. SS7 (Common Channel Signaling System 7) dictates that call control information traverse a separate network dedicated solely to transmitting the required information to successfully connect telephone calls. There are a variety of suitable SS7 interconnect nodes 90 that will suffice for present purposes, such as the Cisco SS7 Interconnect for Voice Gateways which enables a broad portfolio of packet-based voice services.

All components, including the web-servers 30, SQL Server 45, soft switch 80, and/or SS7 interconnect node 90, are preferably maintained by an application service provider (ASP), e.g., a third party “Manager”that owns and operates the system.

As stated above, the parents must register/sign up for one of the defined calling plans of choice (FIG. 2) with the third party “Manager” in one of two ways to take advantage of the call intercept platform 40 of the present invention. Sign Up can be done via a parent's personal computer (PC) 10 or over the phone with a Customer Service Representative (CSR) at the third party “Manager's” Customer Service Department. Once done, the parents can access the call intercept platform from their own PC 10 or over the phone with a Customer Service Representative at the third party “Manager's” Customer Service Department, who will access the call intercept platform 40 on their behalf. The parental PC 10 connects through the Internet 20 to a web server 30, which in turn accesses the call intercept platform 40. A secure parental web portal is implemented as a URL system stored on the sequel server 45 maintained at the ASP Manager's call intercept platform 40, and communicating over the Internet 20 via front-end web server 30.

Parents access the secure website via a singular URL and are presented with a home page. A login button on the home page allows parents (as well as the ASP Manager) to access login screens prompting for a login ID and password. Each successful login is assigned prescribed rights. Parents are assigned limited rights and access to their User Profile inclusive of their parental control Ruleset for their child's mobile phone.

Once a Ruleset has been defined for a child's mobile phone, all calls from that mobile phone 50 are directed to soft switch 80 and/or the SS7 interconnect node 90, which coordinates screening with the sequel server (SQL) 45 maintained at the ASP Manager's call intercept platform 40.

The calls are then managed in accordance with the pre-programmed parental control Ruleset. The soft switch 80 and/or the SS7 interconnect node 90 takes each outgoing call and checks the Ruleset at the sequel (SQL) server(s) 45. If the call is permissible, the soft switch 80 and/or the SS& interconnect node 90 hands the call off to a public switched telephone network (PSTN) 70. The mechanics of the foregoing system and method will now be described in detail.

Step 2—Registration/Sign Up

1.) Newly subscribed parents sign up for the present service via an online registration at the front-end web-servers 45 maintained by the ASP, in order to initialize their Username and Password. All initial setups and sign ups can also be done by telephone with assistance from a CSR, with parents's consent and guidance.

2.) The parent or CSR selects the Control and Monitoring Applications button on the web portal, which directs them to a secure web page that allows them to complete their User Profile, in which they identify outgoing/incoming 10-digit telephone numbers to be allowed or disallowed, as well as permissible times of day, days of week, etc., for making/receiving calls.

3.) The parent or CSR determines what Type of Call Blocking to apply to their Service, as follows:
a) All calls may be allowed by default, and specific 10-digit phone numbers may be blocked; or
b) All calls are denied by default, and specific 10-digit phone numbers may be allowed; and
c) All times of day, days of week, etc., are by default designated as being permissible for making calls, with specific times designated as blocked; or
d) All times of day, days of week, etc., are defaulted as being blocked, and specific times are designated as allowed.

Given the basic ruleset, programming continues as follows:

4.) The parent or CSR builds a customized list of 10-digit phone numbers, which will be blocked or allowed depending on their choice in #3a & 3b above. Customized List Phone Numbers can be added, deleted or changed at any time. This allows the parent to give the mobile phone to their child, with peace of mind, knowing that the child will be unable to communicate with strangers.

5) The parent or CSR builds a calendar of time periods and days, which will be blocked or allowed depending on their choice in #3c & 3d above. Customized calendars can be added, deleted or changed at any time. For example, a father may approve outgoing calls from his daughter only during non-school hours, and further, may approve outgoing phone calls only during the weekends. These parameters can be selected independently or in combination with the list of preauthorized phone numbers in step 4.

6.) The parent or CSR selects “Save” to activate their changes and store them in the Sequel Server database 45 maintained by the ASP. Changes are effective immediately, but will not interrupt a call in progress.

Step 6: Call Intercept

As stated above, each subscriber mobile phone 50 can initiate an outbound call and reach the call intercept platform 40 in a number of ways: (1) manually dialing the 10-digit telephone number of the soft switch 80; or, (2) depressing a preprogrammed Speed Dial Number of the soft switch 80; (3) manually dialing the destination 10-digit number; (4) depressing a preprogrammed Speed Dial Number of the destination 10-digit number; (5) the mobile phone 50 is programmed to initiate all outgoing calls by first dialing the dedicated number of the call intercept platform 40, and then transmitting the destination call number; or, (6) the mobile phone 50 signals to an SS7 interconnection node 90. In all cases, every outgoing call is routed through the call intercept platform 40, and upon connection the mobile phone 50 is identified along with the ten-digit destination call number. Soft switch 80 and/or the SS7 interconnection node 90 then cross-checks the originator and the call with the sequel (SQL) servers database 45 maintained by the ASP, in order to identify the child's mobile phone, account Calling Plan, and preprogrammed Ruleset corresponding to that phone/user. The soft switch 80 and/or the SS7 interconnection node 90 retrieves the Ruleset from SQL server 45, and the outgoing call is then screened in accordance with the child/user's plan type, 10-digit telephone call list/calendar parameters stored in the SQL database 45 and ultimately completed or denied, as appropriate. If the call is rejected, the Caller hears an Error Message and is either prompted to enter another number to call or call the Customer Service Department for assistance. If the call is permitted, the soft switch 80 and/or the interconnection node 90 initiates a call to the requested 10-digit telephone number and completes the connection of the call via the Public Switched Telephone Network (PSTN) 70. The child will hear the phone ringing, busy signal, or other signaling from the PSTN 70, as if they made the call without interception directly.

In addition to call screening, all outgoing calls are tracked and an indexed list of call activity is maintained at the call intercept platform 40 for “real-time” on-line reviewing by the parents.

Incoming calls may be processed and screened in a like manner as described above, although these calls are typically initiated by a third party caller dialing the child's mobile number directly, thereby originating from the PSTN 70. In this case, incoming calls must be processed and routed to the call intercept platform 40 for allowance or disallowance according to the User Profile and Ruleset. The soft switch server(s) 80 and/or the SS7 interconnection node 90, maintained by the ASP, identifies the destination mobile phone and account plan type, plus the preprogrammed Ruleset corresponding to that user's phone. The incoming call is then screened in accordance with the call list and calendar parameters stored in the SQL database 45, and is completed or denied as appropriate. If denied, the Caller hears an Error Message. If the call is permitted, the soft switch 80 reroutes the call back to the Public Switched Telephone Network (PSTN) 70, and the incoming call is completed.

As with outgoing calls, all incoming calls are tracked and an indexed list of incoming call activity is maintained at the call intercept platform 40 for “real-time” on-line reviewing by the parents.

The present system also allows secure web-based preprogrammed speed dialing of authorized numbers from the mobile phone. Parents can set up speed dial numbers from the same web portal by logging onto the home page at the call intercept platform 40, selecting a “Speed Dial” button, and entering 10-digit telephone numbers to be stored as Speed Dial Numbers 1-9999. By then pressing an “Update List” button speed dial numbers can be stored. The child can then initiate a permissible call as set forth above, and need only select a “Speed Dial Number 1-9999” plus “*”on their mobile handset. The preprogrammed 10-digit number is automatically dialed. Again, the soft switch 80 and/or the SS7 interconnection node 90 will compare the stored Ruleset in the Sequel Server(s) database 45 in order to determine if the child is permitted to make calls to the 10-digit number associated with the speed dial number. If not, the caller will hear an Error Message; and, if so, the soft switch 80 and/or the SS7 interconnection node 90 will initiate the call to the requested 10-digit telephone number and completes the connection of the call via the PSTN 70.

Checking Current/“Real Time” Usage Activity and Recent Call History.

Parents may access the secure web portal at server(s) 30, select a Control and Monitoring URL, and then select a link to a Current Activity/Recent Call History. This displays a web page containing the most recent 20 calls, including any currently active calls. Calls are sorted with the most recent calls first. The Recent Call History Page includes an option to specify an alternate date range for display. It also includes the ability to search for specific to or from numbers.

Similar secure web pages are available for allowing the purchase of additional prepaid minutes and for managing their account financials, by eliminating unwanted monthly call usage overcharges

It should now be apparent that the above-described system and method facilitates the implementation of customizable parental controls for wireless telephones via the call-intercept platform 40, inclusive of web server(s) 30, sequel server(s) 45, soft switch(es) 80, and/or an SS7 interconnection node 90. The wireless system and method provides parents with a simple, secure web portal for thoroughly managing their child's phone, inclusive of viewing calls, activating and deactivating parental controls, customizing parental controls, as well as purchasing prepaid minutes and managing their monthly accounts by eliminating unwanted call usage overcharges.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A system for implementing call controls for wireless telephones, comprising of:
a Public Switched Telephone Network;
a call intercept platform including a soft switch in communication with said Public Switched Telephone Network, a secure web-enabled server in communication with said soft switch, and an SQL server in communication with the web-enabled server;
a ruleset of control parameters stored in a database on said SQL server;
a graphical user interface stored on said secure web-enabled server for allowing authorized users to add, modify or delete control parameters from said ruleset; and
a mobile phone assigned a unique phone number, said mobile phone being adapted to route all outgoing calls to said soft switch for screening in accordance with the ruleset of control parameters residing in said SQL server database.

2. The system for implementing call controls for wireless telephones according to claim 1, wherein said Public Switched Telephone Network is programmed to forward all incoming calls to said unique mobile phone number to said soft switch for screening by said call intercept platform in accordance with said ruleset of control parameters.

3. A wireless system for implementing parental controls for wireless telephones according to claim 1, wherein said mobile phone is intended for purchase by a parent for use by their child, and said graphical user interface stored on the web-enabled server is adapted to allow parent can review said outgoing calls and said incoming calls by said child on a real-time basis through said secure web-enabled server.

4. A wireless system for implementing parental controls for wireless telephones according to claim 3, wherein said outgoing calls are routed to said soft switch by manually dialing the 10-digit telephone number of said soft switch from said mobile phone.

5. A wireless system for implementing parental controls for wireless telephones according to claim 3, wherein said outgoing calls are routed to said soft switch by depressing a preprogrammed speed dial number of said soft switch on said mobile phone.

6. A wireless system for implementing parental controls for wireless telephones according to claim 3, wherein said outgoing calls are automatically routed to said soft switch upon dialing any destination 10-digit number.

7. A wireless system for implementing parental controls for wireless telephones according to claim 6, wherein said automatic routing of outgoing calls further comprises dialing said dedicated number of said call intercept platform upon dialing any destination 10-digit number, and transmitting the dialed number to said soft switch.

8. A wireless system for implementing parental controls for wireless telephones according to claim 1, wherein said ruleset by default allows all outgoing calls but selectively blocks specific 10-digit phone numbers entered into the ruleset of control parameters residing in said SQL server database via the graphical user interface stored on said secure web-enabled server.

9. A wireless system for implementing parental controls for wireless telephones according to claim 1, wherein said ruleset by default blocks all outgoing calls but selectively allows specific 10-digit phone numbers entered into the ruleset of control parameters residing in said SQL server database via the graphical user interface stored on said secure web-enabled server.

10. A wireless system for implementing parental controls for wireless telephones according to claim 1, wherein said ruleset by default allows all calls subject to specified times for blocking calls.

11. A wireless system for implementing parental controls for wireless telephones according to claim 1, wherein said ruleset by default blocks all calls subject to specified times for allowing calls.

12. A system for implementing call controls for wireless telephones, comprising:
a Public Switched Telephone Network;
a call intercept platform including an SS7 interconnection node in communication with said Public Switched Telephone Network, a secure web-enabled server in communication with said soft switch, and an SQL server in communication with the web-enabled server;
a ruleset of control parameters stored in a database on said SQL server;
a graphical user interface stored on said secure web-enabled server for allowing authorized users to add, modify or delete control parameters from said ruleset; and
a mobile phone assigned a unique phone number, said mobile phone being adapted to signal each outgoing call on said mobile phone to said SS7 interconnection node for screening in accordance with the ruleset of control parameters residing in said SQL server database.

13. A wireless system for implementing parental controls for wireless telephones according to claim 12, wherein said graphical user interface stored on the web-enabled server is adapted to allow parent can review said outgoing calls and said incoming calls by said child on a real-time basis through said secure web-enabled server.

14. A wireless system for implementing parental controls for wireless telephones according to claim 13, wherein said outgoing calls are signaled to said SS7 interconnection node automatically after dialing any destination 10-digit number.

15. A wireless system for implementing parental controls for wireless telephones according to claim 13, wherein said ruleset by default allows all outgoing calls but selectively blocks specific 10-digit phone numbers entered into the ruleset of control parameters residing in said SQL server database via the graphical user interface stored on said secure web-enabled server.

16. A wireless system for implementing parental controls for wireless telephones according to claim 13, wherein said ruleset by default blocks all outgoing calls but selectively allows specific 10-digit phone numbers entered into the ruleset of control parameters residing in said SQL server database via the graphical user interface stored on said secure web-enabled server.

17. A wireless system for implementing parental controls for wireless telephones according to claim 13, wherein said ruleset by default allows all calls subject to specified times for blocking calls.

18. A wireless system for implementing parental controls for wireless telephones according to claim 13, wherein said ruleset by default blocks all calls subject to specified times for allowing calls.

19. A wireless system for implementing parental controls for wireless telephones, comprising:
a mobile cellular telephone adapted for wireless communication over a public switched telephone network (PSTN), said cellular telephone being preprogrammed to initiate any outgoing call by first dialing a dedicated call intercept number, and said cellular telephone being intended for sale to a parent for use by their child;
a call intercept platform for receiving calls from said cellular telephone to said dedicated call intercept number, said call intercept platform comprising at least one secure web-enabled server, at least one SQL server in network communication with the web server, and a soft ware switching solution in communication with said PSTN and said SQL server, and a web portal resident on said web server and defining a graphical user interface for allowing a parent to specify a parental control ruleset for a child comprising a list of permissible telephone numbers to be allowed, and permissible times of day and days of week for making and receiving calls, once defined said parental control ruleset being compiled and stored on said SQL server;
said cellular telephone being intended for use by said child, whereby when said child initiates outgoing calls using said cellular telephone, said outgoing calls from the mobile phone are routed to the soft switch and are checked in accordance with the parental control ruleset stored on said SQL server and are screened in accordance with the stored ruleset of permissible telephone numbers and times, whereby permissible calls are switched back to said PSTN for completion.

20. A wireless system for implementing parental controls for wireless telephones according to claim 19, wherein said parent can review said outgoing calls and said incoming calls by said child on a real-time basis through said secure web-enabled server.

21. A wireless system for implementing parental controls for wireless telephones according to claim 19, wherein upon making each outgoing call the PSTN is programmed to automatically send the dialed number and mobile cellular telephone identity to the SS7 interconnection node for screening in accordance with said ruleset.

22. A wireless system for implementing parental controls for wireless telephones according to claim 19, wherein said ruleset comprises of allowing all said calls by default and blocking specific 10-digit phone numbers.

23. A wireless system for implementing parental controls for wireless telephones according to claim 24, wherein said ruleset comprises of denying all of said calls by default and allowing said specific 10-digit phone numbers.

24. A wireless system for implementing parental controls for wireless telephones according to claim 19 wherein said ruleset comprises of allowing all times for making calls and blocking specific times.

25. A wireless system for implementing parental controls for wireless telephones according to claim 19 wherein said ruleset comprises of blocking all times and allowing specific times.

26. A method for implementing parental controls for wireless telephones, comprising the steps of:
programming a cellular telephone to initiate any outgoing call by first communicating with a call intercept platform comprising at least one secure web-enabled server, at least one SQL server in network communication with the web server; and a web portal resident on said web-enabled server, said web server defining a graphical user interface for allowing a parent to specify a parental control ruleset;
marketing said mobile cellular telephone and a wireless service plan subscription to parents for purchase on their child's behalf, said cellular telephone being adapted for wireless communication over a public switched telephone network (PSTN);
entering via said graphical user interface a control ruleset for said child comprising a list of permissible telephone numbers to be allowed, and permissible times of day and days of week for making and receiving calls;
compiling said parental control ruleset and storing it on said SQL server;
initiating an outgoing call using said cellular telephone;
screening said outgoing call in accordance with the parental control ruleset stored on said SQL server;
allowing permissible calls for completion and blocking screened calls.

27. A method for implementing parental controls for wireless telephones according to claim 26, wherein said wireless service plan is a pre-paid plan.

28. A method for implementing parental controls for wireless telephones according to claim 26, wherein said wireless service plan is a post-paid plan with allocated minutes.

29. A method for implementing parental controls for wireless telephones according to claim 26, wherein said wireless service plan is a hybrid of said pre-paid plan and said post-paid plan.
